(19) United States
(12) Patent Application Publication
(10) Pub. No.: US 2009/0087740 A1
(43) Pub. Date: Apr. 2, 2009

(54) NON-AQUEOUS ELECTROLYTE SECONDARY BATTERY

(76) Inventors: Masaki Deguchi, Hyogo (JP); Hiroshi Matsuno, Osaka (JP); Shuji Tsutsumi, Nara (JP); Takashi Takeuchi, Osaka (JP); Masamichi Onuki, Kanagawa (JP); Shinichi Kinoshita, Chiba (JP)

Correspondence Address: MCDERMOTT WILL & EMERY LLP, 600 13TH STREET, NW, WASHINGTON, DC, 20005-3096, US

(21) Appl. No.: 11/994,923

(22) PCT Filed: Jul. 6, 2006
(86) PCT No.: PCT/JP2006/313485

§ 371 Date: Jan. 7, 2008

(30) Foreign Application Priority Data
Jul. 7, 2005 (JP) 2005-198894

(51) Int. Cl. H01M 10/40; H01M 4/66; H01M 4/58

(52) U.S. Cl. 429/200; 429/199

(57) ABSTRACT

The invention intends to provide a high-capacity type non-aqueous electrolyte secondary battery that includes a nickel-containing lithium composite oxide as a positive electrode active material and exhibits good charge/discharge cycle characteristics even under a high temperature environment.

The invention is a non-aqueous electrolyte secondary battery including: a positive electrode including a nickel-containing lithium composite oxide as a positive electrode active material; a negative electrode capable of absorbing and desorbing lithium; a separator interposed between the positive electrode and the negative electrode; and a non-aqueous electrolyte including a non-aqueous solvent and a solute dissolved in the non-aqueous solvent. In the nickel-containing lithium composite compound after a discharge to a predetermined cut-off voltage of discharge, the molar ratio r of lithium to the other metal elements than lithium is 0.85 or more and 0.92 or less. The non-aqueous electrolyte includes a fluorine-containing sulfonate compound.

### TECHNICAL FIELD

The present invention relates to non-aqueous electrolyte secondary batteries, and more particularly, to a non-aqueous electrolyte secondary battery with an improved non-aqueous electrolyte.

### BACKGROUND ART

In the field of non-aqueous electrolyte secondary batteries, there have recently been a lot of studies on lithium ion secondary batteries with high voltage and high energy density.

At present, in most of commercially available lithium ion secondary batteries, LiCoO₂, which exhibits a high charge/discharge voltage, is used as a positive electrode active material. Meanwhile, there is a strong demand for higher capacity, and research and development is extensively conducted on positive electrode active materials with higher capacities than LiCoO₂. Among them, nickel-containing lithium composite oxides composed mainly of nickel, such as LiNiO₂, are being intensively studied and some of them have already been commercialized.

Also, lithium ion secondary batteries are required to have higher reliability and longer life as well as higher capacity. However, since nickel-containing lithium composite oxides such as LiNiO₂ are generally significantly inferior to LiCoO₂ in cycle characteristics and storage characteristics, only part of them have been commercialized. Hence, in order to improve the characteristics of nickel-containing lithium composite oxides, their improvements are actively being made.

For example, it has been reported that the use of LiₐM_{b}Ni_{c}CO_{d}Oₑ (M is at least one metal element selected from the group consisting of Al, Mn, Sn, In, Fe, V, Cu, Mg, Ti, Zn, and Mo, 0<a<1.3, 0.02≦b≦0.5, 0.02≦d/c+d≦0.9, 1.8<e<2.2, and b+c+d=1) can reduce a change in crystal structure, thereby enhancing capacity and thermal stability (see Patent Document 1).

Meanwhile, non-aqueous electrolytes used in non-aqueous electrolyte secondary batteries generally contain a non-aqueous solvent and a solute dissolved therein. Examples of non-aqueous solvents used include cyclic carbonic acid esters, chain carbonic acid esters, and cyclic carboxylic acid esters. Examples of solutes used include lithium hexafluorophosphate (LiPF₆) and lithium tetrafluoroborate (LiBF₄).

To improve battery performance, attempts have been made to mix various additives with a non-aqueous electrolyte, a positive electrode active material and/or a negative electrode active material.

For example, the addition of a fluorine-containing sulfonate compound to a non-aqueous electrolyte has been proposed to improve high-temperature storage characteristics (see Patent Document 2). In Patent Document 2, the fluorine-containing sulfonate compound adsorbs to the negative electrode surface and the positive electrode surface or reacts with the surface substance thereon, so that a coating film is formed on the surface thereof. As a result, side reaction between the electrolyte and the active material is suppressed.

Patent Document 1: Japanese Laid-Open Patent Publication No. Hei 5-242891

### Patent Document 2: Japanese Laid-Open Patent Publication No. 2003-331920

### DISCLOSURE OF INVENTION

### Problem to be Solved by the Invention

However, according to the conventional technique proposed by Patent Document 1, the batteries using the nickel-containing lithium composite oxides have failed to provide sufficient cycle characteristics.

Also, when a fluorine-containing sulfonate compound is contained in a non-aqueous electrolyte, as proposed in Patent Document 2, the battery impedance rises, thereby impeding the charge/discharge reactions. As a result, a problem of significant degradation of cycle characteristics occurs.

It is therefore an object of the present invention to provide a high-capacity type non-aqueous electrolyte secondary battery that uses a nickel-containing lithium composite oxide as a positive electrode active material and exhibits good charge/discharge cycle characteristics even in a high-temperature environment.

### Means for Solving the Problem

The present inventors have analyzed the causes of such problems and conducted elaborate investigations. As a result, they have found that a fluorine-containing sulfonate compound has a special effect on a certain nickel-containing lithium composite oxide, thereby remarkably suppressing side reaction between the non-aqueous electrolyte and the positive electrode active material.

That is, the present invention relates to a non-aqueous electrolyte secondary battery including: a positive electrode including a nickel-containing lithium composite oxide as a positive electrode active material; a negative electrode capable of absorbing and desorbing lithium; a separator interposed between the positive electrode and the negative electrode; and a non-aqueous electrolyte including a non-aqueous solvent and a solute dissolved in the non-aqueous solvent. In the nickel-containing lithium composite compound after a discharge to a predetermined cut-off voltage of discharge, the molar ratio r of lithium to the other metal elements than lithium is 0.85 or more and 0.92 or less. The non-aqueous electrolyte includes a fluorine-containing sulfonate compound.

As used herein, “after a discharge to a predetermined cut-off voltage of discharge” refers to after a charge and at least one discharge to a predetermined cut-off voltage of discharge. The predetermined cut-off voltage of discharge can be determined, for example, depending on the combination of the above-mentioned nickel-containing lithium composite oxide and a predetermined negative electrode active material. For example, in the case of using lithium metal or graphite as a negative electrode active material, when a nickel-containing lithium composite oxide that exhibits a high voltage in the final stage of discharge, such as LiNiMnCoO₂, is used as a positive electrode active material, it is common to set the cut-off voltage of discharge to 3 V. Also, when a nickel-containing lithium composite oxide that exhibits a gradual decline in voltage in the final stage of discharge, such as LiNiCoAlO₂, is used as a positive electrode active material, it is preferable to set the cut-off voltage of discharge to 2.5 V in order to increase capacity. Also, in the case of using hard carbon or alloy as a negative electrode active material, the discharge voltage of such a negative electrode is not flat but increases gradually. When such a negative electrode is used, the discharge voltage of the battery is low, and hence the cut-off voltage of discharge is set low to secure capacity. When a nickel-containing lithium composite oxide that exhibits a high voltage in the final stage of discharge, such as LiNiMnCoO₂, is used as a positive electrode active material, the cut-off voltage of discharge is set to 2.5 V. When a nickel-containing lithium composite oxide that exhibits a gradual decline in voltage in the final stage of discharge, such as LiNiCoAlO₂, is used, the cut-off voltage of discharge is set to 2 V. Even when the cut-off voltage of discharge is changed as described above, the present invention uses a positive electrode active material in which the molar ratio r falls within the range of 0.85 to 0.92.

After the non-aqueous electrolyte secondary battery is discharged to the predetermined cut-off voltage of discharge, the nickel-containing lithium composite oxide is preferably an oxide represented by the following general formula (1):

LiₐNiₓM_{1-x-y}L_{y}O₂

where M is at least one of Co and Mn, L is at least one selected from the group consisting of Al, Sr, Mg, Ti, Ca, Y, Zr, Ta, Zn, B, Cr, Si, Ga, Sn, P, V, Sb, Nb, Mo, W, and Fe, 0.85≦a≦0.92, 0.1≦x≦1, and 0≦y≦0.1.

In the non-aqueous electrolyte secondary battery, more preferably, L is at least one selected from the group consisting of Al, Sr, Mg, Ti, and Ca.

In the non-aqueous electrolyte secondary battery, the fluorine-containing sulfonate compound is preferably a compound represented by the following general formula (2):

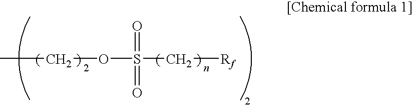

where n is an integer of 1 or higher, and Rf is an aliphatic saturated hydrocarbon group all the hydrogen atoms of which are replaced with fluorine atoms.

In the non-aqueous electrolyte secondary battery, the non-aqueous electrolyte preferably includes 0.1 to 10 parts by weight of the fluorine-containing sulfonate compound per 100 parts by weight of the non-aqueous solvent.

### EFFECTS OF THE INVENTION

In the present invention, the fluorine-containing sulfonate compound effectively interacts with the positive electrode active material, so that an inactive coating film is formed on the positive electrode. As a result, under a high-temperature environment, reaction between the non-aqueous electrolyte and the positive electrode active material is suppressed and degradation of cycle characteristics can be avoided. Therefore, the present invention can realize a non-aqueous electrolyte secondary battery with good battery performance.

### BRIEF DESCRIPTION OF THE DRAWING

FIG. 1 is a schematic longitudinal sectional view of a non-aqueous electrolyte secondary battery according to one embodiment of the present invention.

### BEST MODE FOR CARRYING OUT THE INVENTION

Best modes for carrying out the present invention are hereinafter described.

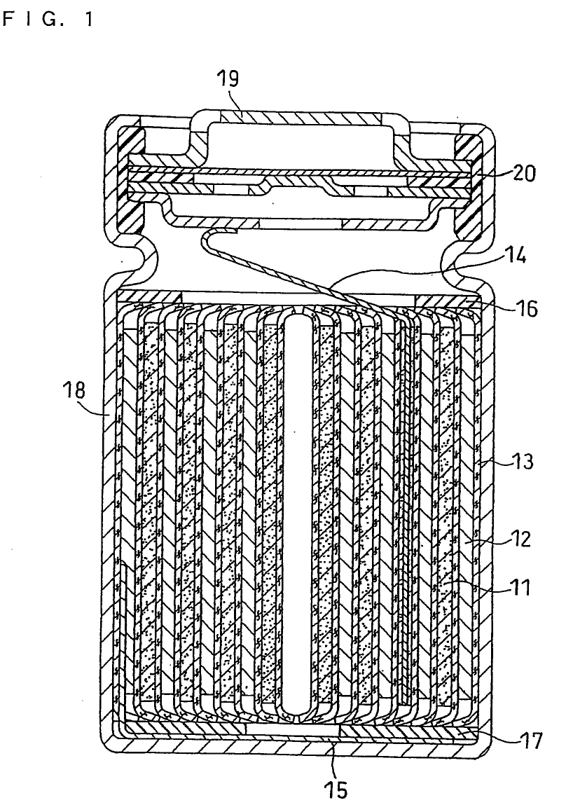

FIG. 1 illustrates a non-aqueous electrolyte secondary battery according to one embodiment of the present invention.

The non-aqueous electrolyte secondary battery of FIG. 1 includes a battery case 18 and a power generating element contained in the battery case 18. The power generating element includes an electrode plate group and a non-aqueous electrolyte (not shown).

The electrode plate group includes a positive electrode plate 11, a negative electrode plate 12, and a separator 13 disposed between the positive electrode plate and the negative electrode plate. The electrode plate group is formed by spirally winding the positive electrode plate 11, the negative electrode plate 12, and the separator 13 inserted between the two electrode plates.

One end of a positive electrode lead 14 is connected to the positive electrode plate 11, while the other end of the positive electrode lead 14 is connected to the backside of a sealing plate 19 serving as a positive electrode terminal. One end of a negative electrode lead 15 is connected to the negative electrode plate 12, while the other end of the negative electrode lead 15 is connected to the bottom of the battery case 18.

An upper insulator plate 16 is disposed on the electrode plate group, while a lower insulator plate 17 is disposed under the electrode plate group.

The opening of the battery case 18 is sealed by crimping the open edge of the battery case 18 onto the sealing plate 19 with a gasket 20 interposed therebetween.

The positive electrode plate 11 includes, for example, a positive electrode current collector and a positive electrode active material layer carried thereon. The positive electrode active material layer contains a positive electrode active material, a binder, and, if necessary, a conductive agent.

The negative electrode plate 12 includes, for example, a negative electrode current collector and a negative electrode active material layer carried thereon. The negative electrode active material layer contains a negative electrode active material, and, if necessary, a binder and a conductive agent.

The non-aqueous electrolyte contains a non-aqueous solvent and a solute dissolved therein. In the present invention, the non-aqueous electrolyte further contains a fluorine-containing sulfonate compound. Examples of fluorine-containing sulfonate compounds include 1,4-butanediolbis(2,2,2-trifluoroethanesulfonate), 1,4-butanediolbis(2,2,3,3,3-pentafluoropropanesulfonate), 1,4-butanediolbis(2,2,3,3,4,4,4-heptafluorobutanesulfonate), 1,4-butanediolbis(3,3,3-trifluoropropanesulfonate), 1,4-butanediolbis(4,4,4-trifluorobutanesulfonate), 1,4-butanediolbis(3,3,4,4,4-pentafluorobutanesulfonate), 1,2,3-propanetriol tris(2,2,2-trifluoroethanesulfonate), 1,2,3-propanetriol tris(2,2,3,3,3-pentafluoropropanesulfonate), and 1,2,3,4-butanetetrol tetrakis(2,2,2-trifluoroethanesulfonate).

As the positive electrode active material, a nickel-containing lithium composite oxide is used. After a discharge to a predetermined cut-off voltage of discharge, the molar ratio r of lithium to the other metal elements than lithium (hereinafter referred to as the molar ratio r) in the nickel-containing lithium composite oxide is 0.85 or more and 0.92 or less.

Usually, on the surface of a nickel-containing lithium composite oxide is a lithium compound such as lithium hydroxide (LiOH) or lithium oxide (Li₂O). For example, the growth of particles of a nickel-containing lithium composite oxide is so slow that an unreacted lithium compound may remain thereon. Also, even when no unreacted lithium compound is present on a nickel-containing lithium composite oxide, a lithium compound may form on the nickel-containing lithium composite oxide due to an atmosphere in a manufacturing process of a battery.

The present inventors have found that the amount of lithium compound on the positive electrode surface is correlated with the molar ratio r, and that when the molar ratio r is in the above-mentioned range, such a nickel-containing lithium composite oxide has an appropriate amount of lithium compound so that the lithium compound reacts with the fluorine-containing sulfonate compound to form a coating film.

That is, when the molar ratio r after a discharge to a predetermined cut-off voltage of discharge is 0.85 to 0.92, an appropriate amount of lithium compound is present on the surface of such a nickel-containing lithium composite oxide. It is thus believed that the lithium compound reacts with the fluorine-containing sulfonate compound, thereby forming an appropriate amount of an inactive lithium fluoride (LiF) coating film on the positive electrode surface. The LiF coating film suppresses side reaction between the non-aqueous electrolyte and the positive electrode active material even at high temperatures. It is thus possible to improve the cycle characteristics of the battery.

It is thought that the reaction between the lithium compound and the fluorine-containing sulfonate compound occurs immediately after the non-aqueous electrolyte is injected into a battery case.

In the present invention, the molar ratio r includes not only the amount of lithium contained in the nickel-containing lithium composite oxide but also the amount of lithium contained in the lithium compound present on the surface thereof. For example, after the LiF coating film is formed, the molar ratio r includes the amount of lithium contained in the nickel-containing lithium composite oxide, the amount of lithium contained in the lithium compound that remained unreacted on the surface of the nickel-containing lithium composite oxide, and the amount of lithium contained in the LiF coating film formed.

It should be noted that the fluorine-containing sulfonate compound is believed to react with only the lithium compound. This is because the nickel-containing lithium composite oxide itself is stable and thus the lithium contained in the nickel-containing lithium composite oxide hardly reacts with the fluorine-containing sulfonate compound. Further, it is thought that the reaction site is limited to the surface of the nickel-containing lithium composite oxide and is not related to the inside of the nickel-containing lithium composite oxide.

If the molar ratio r in the nickel-containing lithium composite oxide after the discharge is less than 0.85, the cycle characteristics degrade under a high-temperature environment. This is probably because the amount of the lithium compound on the positive electrode surface is small and hence the formation of the LiF coating film is insufficient. If the molar ratio r exceeds 0.92, the amount of the lithium compound on the positive electrode surface is excessive, so that the coating film becomes too thick and the charge/discharge reactions are thus impeded.

Among the above-mentioned fluorine-containing sulfonate compounds, the non-aqueous electrolyte preferably includes a fluorine-containing sulfonate compound represented by the following general formula (2):

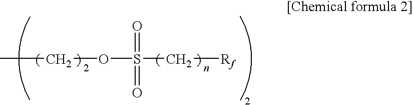

where n is an integer of 1 or higher, and Rf is an aliphatic saturated hydrocarbon group all the hydrogen atoms of which are replaced with fluorine atoms.

The fluorine-containing sulfonate compound represented by the general formula (2) has, in its molecule, two units each containing a sulfonate group and an Rf group. Therefore, the reactivity with the lithium compound on the positive electrode is high, and excessive coating film formation is suppressed and a good coating film can be formed. Also, in the center of the symmetry structure is a butylene group, with a sulfonate group on each side of the butylene group. Hence, four carbon atoms of the butylene group and the oxygen atoms of the respective sulfonate groups can form a stable conformation of six membered ring as represented by the following structural formula:

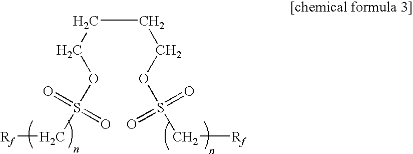

In such a conformation, the two units of the molecule containing the sulfonate groups and the Rf groups are easily aligned stably in the same direction. It is thus believed that the efficiency of the reaction with the lithium compound on the positive electrode is significantly increased.

Among the compounds represented by the general formula (2), 1,4-butanediolbis(2,2,2-trifluoroethanesulfonate)(hereinafter referred to as BBTFES) is more preferable. In BBTFES, one methylene group is sandwiched between a sulfonate group and a CF₃ group. In the case of elimination of the hydrogen atom of the methylene group and the fluorine atom of the CF₃ group, a carbon-carbon double bond is formed between the methylene group from which the hydrogen atom has been eliminated and the CF₂ group. Since π electrons are delocalized in the carbon-carbon double bond and the sulfonate group, the molecules from which the fluorine atom has been eliminated become significantly stable. Thus, in the case of BBTFES, the reaction between the fluorine atom of the CF₃ group and the lithium compound on the positive electrode proceeds properly, so that a particularly good coating film is formed on the positive electrode. Also, since the Rf group is the CF₃ group, BBTFES is also effective for suppressing excessive coating film formation.

The number of carbon atoms contained in the Rf group is preferably 1 or more and 3 or less. If the number of carbon atoms is 4 or more, the reaction between the fluorine atoms of the Rf group and the lithium compound on the positive electrode proceeds too much, thereby resulting in excessive coating film formation. Hence, the charge/discharge reactions may be impeded.

The number n of methylene groups between the sulfonate group and the Rf group is more preferably 1 or more and 3 or less. If n is 4 or more, the effect of the sulfonate group on the Rf group becomes weak, and elimination of the fluorine atoms from the Rf group is unlikely to occur. Hence, the formation of the LiF coating film on the positive electrode may become insufficient.

In the case of a fluorine-containing sulfonate compound whose molecule has three or more units each containing a sulfonate group and an Rf group, the high-temperature cycle characteristics may be slightly lower than those for the compounds represented by the general formula (2). This is probably because the reactivity between such a compound and the lithium compound on the positive electrode is high and a coating film is formed excessively, so that the charge/discharge reactions may be slightly impeded. Also, in the case of a fluorine-containing sulfonate compound whose molecule has one unit containing a sulfonate group and an Rf group, for example, butyl-2,2,2-trifluoroethanesulfonate, the high-temperature cycle characteristics may also be slightly low. This is probably because the reactivity between such a compound and the lithium compound on the positive electrode is low and a coating film is not sufficiently formed, so that side reaction between the non-aqueous electrolyte and the positive electrode active material may not be fully suppressed.

The content of the fluorine-containing sulfonate compound in the non-aqueous electrolyte is preferably 0.1 to 10 parts by weight per 100 parts by weight of the non-aqueous solvent. If the amount of the fluorine-containing sulfonate compound is less than 0.1 part by weight, it may not produce sufficient effect in improving the high-temperature cycle characteristics. If the amount of the fluorine-containing sulfonate compound exceeds 10 parts by weight, the coating film formed on the positive electrode surface becomes too thick, so that the charge/discharge reactions may be impeded.

As the nickel-containing lithium composite oxide, it is preferable to use a composite oxide represented by the following general formula (1A):

Li_{A}Ni_{X}M_{1-x-y}L_{y}O₂

where M is at least one of Co and Mn, L is at least one selected from the group consisting of Al, Sr, Mg, Ti, Ca, Y, Zr, Ta, Zn, B, Cr, Si, Ga, Sn, P, V, Sb, Nb, Mo, W, and Fe, 0≦A≦−1.12, 0.1≦x≦1, and 0≦y≦0.1. It is particularly preferable to use a composite oxide which, after a discharge to a predetermined cut-off voltage of discharge, is represented by the following general formula (1):

LiₐNiₓM_{1-x-y}L_{y}O₂

where M is at least one of Co and Mn, L is at least one selected from the group consisting of Al, Sr, Mg, Ti, Ca, Y, Zr, Ta, Zn, B, Cr, Si, Ga, Sn, P, V, Sb, Nb, Mo, W, and Fe, 0.85≦a≦0.92, 0.1≦x≦1, and 0≦y≦0.1. This is because the element L included therein stabilizes the crystal structure, thereby improving the battery performance.

Also, x in the general formulas (1) and (1A) is more preferably in the range of 0.3≦x≦0.9, and particularly preferably in the range of 0.7≦x≦0.9.

It should be noted that the positive electrode active material may include one or more kinds of nickel-containing lithium composite oxides represented by the general formula (1).

Regardless of which one the element L is of Al, Sr, Mg, Ti, Ca, Y, Zr, Ta, Zn, B, Cr, Si, Ga, Sn, P, V, Sb, Nb, Mo, W, and Fe, if the molar ratio y of L exceeds 0.1, the reaction between the lithium compound on the positive electrode active material surface and the fluorine-containing sulfonate compound is impeded. The formation of the inactive LiF coating film thus becomes insufficient, so that the high-temperature cycle characteristics may degrade slightly. Hence, y is preferably 0.1 or less, more preferably 0.05 or less, and particularly preferably 0.01 to 0.05.

More preferably, the element L is at least one selected from the group consisting of Al, Sr, Mg, Ti, and Ca. Metal oxides containing these elements, such as Al₂O₃ and SrO, have the effect of facilitating the formation of an inactive LiF coating film, so that a good protective film is formed on the positive electrode. As a result, the cycle characteristics can be further improved.

In the general formula (1A), the range of the molar ratio A of lithium is 0≦A≦1.12. For example, when a battery including such a positive electrode active material is charged to a theoretical capacity, the molar ratio A of lithium in the general formula (1A) may become as low as about 0. Also, the upper limit 1.12 of the molar ratio A represents the upper limit of lithium contained in a lithium compound, such as LiOH or Li₂CO₃, which is used to synthesize a nickel-containing lithium composite oxide represented by the general formula (1A).

In the case of using a nickel-containing lithium composite oxide represented by the general formula (1A), the upper limit of the molar ratio r of lithium to the other metal elements than lithium contained in the nickel-containing lithium composite compound after a discharge to a predetermined cut-off voltage of discharge is 0.92, which is lower than the above-mentioned 1.12. This is because part of the lithium that migrated from the positive electrode to the negative electrode is trapped in the negative electrode and cannot return to the positive electrode. Further, an inactive coating film may also be formed on the negative electrode surface, and lithium is used in the formation of such a coating film.

In the case of conventional nickel-containing lithium composite oxides, the molar ratio r after a discharge to a predetermined cut-off voltage of discharge is higher than 0.92. In the present invention, the molar ratio r ranges from 0.85 to 0.92, as described above. In order to make the molar ratio r of lithium in the nickel-containing lithium composite oxide to 0.92 or less, the molar ratio A of lithium contained in the nickel-containing lithium composite oxide is preferably lower than 1, more preferably 0.999 or less, and particularly preferably 0.995 or less.

As the negative electrode active material, various materials known in the art can be used. Examples of the negative electrode active material which can be used include graphites such as natural graphite including flake graphite and artificial graphite, carbon blacks such as acetylene black, ketjen black, channel black, furnace black, lamp black, and thermal black, carbon fiber, metal fiber, alloy, lithium metal, tin compounds, silicides, and nitrides.

Examples of the positive electrode binder and the negative electrode binder which can be used include polyethylene, polypropylene, polytetrafluoroethylene, polyvinylidene fluoride, tetrafluoroethylene-hexafluoropropylene copolymer, and vinylidene fluoride-hexafluoropropylene copolymer.

Examples of the conductive agent which is added to the positive electrode and/or negative electrode include graphites, carbon blacks such as acetylene black, ketjen black, channel black, furnace black, lamp black, and thermal black, carbon fiber, and metal fiber.

An example of the positive electrode current collector used is a foil made of stainless steel, aluminum, or titanium. Also, an example of the negative electrode current collector used is a foil made of stainless steel, nickel, or copper. While the thickness of the positive electrode current collector and the negative electrode current collector is not particularly limited, it is preferably 1 to 500 μm.

Examples of the non-aqueous solvent used in the non-aqueous electrolyte include cyclic carbonic acid esters, chain carbonic acid esters, and cyclic carboxylic acid esters. Examples of cyclic carbonic acid esters include propylene carbonate and ethylene carbonate. Examples of chain carbonic acid esters include diethyl carbonate, ethyl methyl carbonate, and dimethyl carbonate. Examples of cyclic carboxylic acid esters include γ-butyrolactone and γ-valerolactone.

Examples of the solute include LiPF₆, LiClO₄, LiBF₄, LiAlCl₄, LiSbF₆, LiSCN, LiCF₃SO₃, LiCF₃CO₂, Li(CF₃SO₂)₂, LiAsF₆, LiB₁₀Cl₁₀, lithium lower aliphatic carboxylate, LiCl, LiBr, LiI, chloroborane lithium, borates such as lithium bis(1,2-benzenediolate(2-)-O,O′)borate, lithium bis(2,3-naphthalenediolate(2-)-O,O′)borate, lithium bis(2,2′-biphenyldiolate(2-)-O,O′)borate, and lithium bis(5-fluoro-2-olate-1-benzenesulfonic acid-O,O′)borate, and imide salts such as lithium bis(tetrafluoromethanesulfonyl)imide ((CF₃SO₂)₂NLi), lithium tetrafluoromethanesulfonyl nonafluorobutanesulfonyl imide (LiN(CF₃SO₂)(C₄F₉SO₂)), and lithium bis(pentafluoroethanesulfonyl)imide ((C₂F₅SO₂)₂NLi). They may be used singly or in combination of two or more of them.

The non-aqueous electrolyte preferably contains a cyclic carbonic acid ester having at least one carbon-carbon unsaturated bond. This is because it is decomposed on the negative electrode to form a coating film having a high lithium-ion conductivity, so that the charge/discharge efficiency can be increased. The content of the cyclic carbonic acid ester having at least one carbon-carbon unsaturated bond is preferably equal to or less than 10% by weight of the whole non-aqueous solvent.

Examples of cyclic carbonic acid esters having at least one carbon-carbon unsaturated bond include vinylene carbonate, 3-methyl vinylene carbonate, 3,4-dimethyl vinylene carbonate, 3-ethyl vinylene carbonate, 3,4-diethyl vinylene carbonate, 3-propyl vinylene carbonate, 3,4-dipropyl vinylene carbonate, 3-phenyl vinylene carbonate, 3,4-diphenyl vinylene carbonate, vinyl ethylene carbonate, and divinyl ethylene carbonate. They may be used singly or in combination of two or more of them. Among them, at least one selected from the group consisting of vinylene carbonate, vinyl ethylene carbonate, and divinyl ethylene carbonate is preferable. In these compounds, part of the hydrogen atoms may be replaced with fluorine atoms.

Further, the non-aqueous electrolyte may contain a known benzene derivative that is decomposed during overcharge to form a coating film on the electrode, thereby inactivating the battery. The benzene derivative preferably contains a phenyl group and a cyclic compound group adjacent to the phenyl group. The cyclic compound group is preferably a phenyl group, a cyclic ether group, a cyclic ester group, a cycloalkyl group, a phenoxy group, etc. Specific examples of benzene derivatives include cyclohexyl benzene, biphenyl, and diphenyl ether. They may be used singly or in combination of two or more of them. However, the content of the benzene derivative is preferably equal to or less than 10% by volume of the whole non-aqueous solvent.

The separator can be an insulating microporous thin film having high ion-permeability and predetermined mechanical strength. Examples of such separators include sheets, non-woven fabrics, and woven fabrics made of olefin polymers, such as polypropylene and polyethylene, or glass fiber. Generally, the thickness of the separator is preferably 10 to 300 μm.

The present invention is hereinafter described based on Examples.

### EXAMPLE

### Example 1

### (i) Preparation of Non-Aqueous Electrolyte

A solution was prepared by dissolving LiPF₆ at a concentration of 1.0 mol/L in a solvent mixture (volume ratio 1:4) of ethylene carbonate (EC) and ethyl methyl carbonate (EMC). The solution was mixed with 1 part by weight of BBTFES per 100 parts by weight of the solvent mixture, to prepare a non-aqueous electrolyte.

### (ii) Preparation of Positive Electrode Plate

A mixture was prepared by mixing 85 parts by weight of a positive electrode active material (Li_{0.97}Ni_{0.8}CO_{0.2}O₂) powder, 10 parts by weight of an acetylene black conductive agent, and 5 parts by weight of a polyvinylidene fluoride (PVDF) binder. The mixture was dispersed in dehydrated N-methyl-2-pyrrolidone (NMP) to prepare a positive electrode mixture slurry. This positive electrode mixture was applied onto both sides of a positive electrode current collector made of aluminum foil, dried, and rolled to obtain a positive electrode plate.

### (iii) Preparation of Negative Electrode Plate

A mixture was prepared by mixing 75 parts by weight of artificial graphite powder, 20 parts by weight of an acetylene black conductive agent, and 5 parts by weight of a PVDF binder. The mixture was dispersed in dehydrated NMP to prepare a negative electrode mixture slurry. This negative electrode mixture was applied onto both sides of a negative electrode current collector made of copper foil, dried, and rolled to obtain a negative electrode plate.

### (iv) Fabrication of Cylindrical Battery

A cylindrical battery as illustrated in FIG. 1 was produced.

A positive electrode plate 11 and a negative electrode plate 12 prepared in the above manner, and a separator 13 interposed between the positive electrode plate 11 and the negative electrode plate 12 were spirally wound to form an electrode plate group. One end of an aluminum positive electrode lead 14 was connected to the positive electrode plate 11, and one end of a nickel negative electrode lead 15 was connected to the negative electrode plate 12.

Subsequently, an upper insulator plate 16 was disposed on the electrode plate group, while a lower insulator plate 17 was disposed under the electrode plate group. The electrode plate group was placed in a battery case 18 made of nickel plated iron. The other end of the positive electrode lead 14 was connected to the backside of a sealing plate 19 serving as the positive electrode terminal. The other end of the negative electrode lead 15 was connected to the bottom of the battery case 18.

Thereafter, a predetermined amount of the non-aqueous electrolyte prepared in the above manner was injected into the battery case 18. The open edge of the battery case 18 was then crimped onto the sealing plate 19 with a gasket 20 interposed therebetween to seal the opening of the battery case 18. In this way, a non-aqueous electrolyte secondary battery 1 with a nominal capacity of 1.5 Ah was produced.

### (v) Measurement of the Molar Ratio r of Lithium to the Other Metal Elements than Lithium in the Nickel-Containing Lithium Composite Oxide after a Discharge to a Predetermined Cut-Off Voltage of Discharge

The battery 1 was charged at 20° C. at a current of 1050 mA until the battery voltage reached 4.2 V and then charged at a constant voltage of 4.2 V. The total charging time was set to 2 hours and a half.

After the charged battery was allowed to stand for 10 minutes, it was discharged at a predetermined current until the battery voltage dropped to 2.5 V. The predetermined current was set such that the discharge hour rate was approximately 0.01 C to 0.2 C. In the following Examples, the discharge current was set to 150 mA (0.1 C).

Subsequently, the discharged battery was disassembled, and the positive electrode active material layer was taken out and its weight was measured. Thereafter, by adding an acid to the positive electrode active material layer and heating it, the positive electrode active material layer was dissolved. The resultant solution of the positive electrode active material layer was adjusted to a predetermined volume, and the solution was analyzed by ICP emission spectral analysis and atomic absorption spectroscopy to determine the molar ratio r. Table 1 shows the resultant values.

### (vi) Evaluation of Battery

The battery 1 was charged at 45° C. at a current of 1050 mA until the battery voltage reached 4.2 V and then charged at a constant voltage of 4.2 V. The total charging time was set to 2 hours and a half.

After the charged battery was allowed to stand for 10 minutes, it was discharged at a current of 1500 mA until the battery voltage dropped to 3.0 V. This charge/discharge cycle was repeated 500 times. The ratio of the discharge capacity at the 500^{th} cycle to the discharge capacity at the 3^{rd} cycle was expressed as a percentage, and this value was defined as the capacity retention rate. Table 1 shows the results.

### Comparative Example 1

A battery 2 was produced in the same manner as in Example 1, except that BBTFES was not added to the non-aqueous electrolyte. The molar ratio r and the capacity retention rate of the battery 2 were measured in the same manner as in Example 1. Table 1 shows the results. The battery 2 is a comparative battery.

### Comparative Example 2

A battery 3 was produced in the same manner as in Example 1, except for the use of lithium cobaltate (Li_{1.0}CO_{1.0}O₂) as the positive electrode active material. The molar ratio r and the capacity retention rate of the battery 3 were measured in the same manner as in Example 1. Table 1 shows the results. The battery 3 is a comparative battery.

### Comparative Example 3

A battery 4 was produced in the same manner as in Example 1, except that lithium cobaltate (Li_{1.0}CO_{1.0}O₂) was used as the positive electrode active material and that BBTFES was not added to the non-aqueous electrolyte. The molar ratio r and the capacity retention rate of the battery 4 were measured in the same manner as in Example 1. Table 1 shows the results. The battery 4 is a comparative battery.

Table 1 also shows the composition formulas of the positive electrode active materials used. The molar ratios of the respective elements in the composition formulas of the positive electrode active materials shown in Table 1 are the molar ratios of the raw materials used for synthesis thereof. This also applies to the following Tables.

TABLE 1

| | | | Amount of | Capacity |
|---|---|---|---|---|
| | Positive | | BBTFES | retention |
| | electrode active | Molar | added (parts | rate |
| | material | ratio r | by weight) | (%) |
| Battery 1 | Li_{0.97}Ni_{0.8}Co_{0.2}O₂ | 0.90 | 1 | 85.5 |
| Comp. Battery 2 | Li_{0.97}Ni_{0.8}Co_{0.2}O₂ | 0.90 | — | 37.1 |
| Comp. Battery 3 | Li_{1.0}Co_{1.0}O₂ | 0.90 | 1 | 35.3 |
| Comp. Battery 4 | Li_{1.0}Co_{1.0}O₂ | 0.90 | — | 35.8 |

Table 1 shows that only the battery 1, in which the nickel-containing lithium composite oxide with a molar ratio r of 0.90 was used as the positive electrode active material and BBTFES was added to the non-aqueous electrolyte, exhibits a significant improvement in cycle characteristics in comparison with the other batteries. This is probably because the compound on the positive electrode active material surface reacted with the fluorine-containing sulfonate compound, thereby forming a protective film on the positive electrode.

When lithium cobaltate or the like was used as the positive electrode active material, even if the fluorine-containing sulfonate compound represented by the general formula (2) was used, the capacity retention rate was very low, as shown by the comparative batteries 3 and 4. When the positive electrode active material was lithium cobaltate or the like, even if other fluorine-containing sulfonate compounds were used, the capacity retention rate was very low, in the same manner as in the comparative batteries 3 and 4.

### Example 2

Batteries 5 to 10 were produced in the same manner as in Example 1, except that the positive electrode active materials shown in Table 2 were used as the positive electrode active material and that the molar ratio r was varied as shown in Table 2. The battery 5 and the battery 10 are comparative batteries. The battery 7 is the same battery as the battery 1.

The molar ratios r of these batteries were measured in the same manner as in Example 1. Also, the capacity retention rates of these batteries were measured in the same manner as in Example 1. Table 2 shows the results.

TABLE 2

| | | | Amount of | Capacity |
|---|---|---|---|---|
| | | | BBTFES | retention |
| | Positive electrode | Molar | added (parts | rate |
| | active material | ratio r | by weight) | (%) |
| Comp. | Li_{1.0}Ni_{0.8}Co_{0.2}O₂ | 0.94 | 1 | 69.9 |
| Battery 5 | | | | |
| Battery 6 | Li_{0.995}Ni_{0.8}Co_{0.2}O₂ | 0.92 | 1 | 80.3 |
| Battery 7 | Li_{0.97}Ni_{0.8}Co_{0.2}O₂ | 0.90 | 1 | 85.5 |
| Battery 8 | Li_{0.96}Ni_{0.8}Co_{0.2}O₂ | 0.87 | 1 | 83.5 |
| Battery 9 | Li_{0.955}Ni_{0.8}Co_{0.2}O₂ | 0.85 | 1 | 80.8 |
| Comp. | Li_{0.95}Ni_{0.8}Co_{0.2}O₂ | 0.83 | 1 | 71.5 |
| Battery 10 | | | | |

Table 2 shows that when the molar ratio r is less than 0.85, the high-temperature cycle characteristics are low. This is probably because the formation of the coating film on the positive electrode is insufficient. It also shows that when the molar ratio r is greater than 0.92, the high-temperature cycle characteristics are also low. This is probably because the coating film is too thick, thereby impeding the charge/discharge reactions.

It can therefore be understood that when the molar ratio r is 0.85 or more and 0.92 or less, the high-temperature cycle characteristics can be improved.

### Example 3

Batteries 11 to 46 were produced in the same manner as in Example 1, except that the positive electrode active materials shown in Table 3 to Table 5 were used as the positive electrode active material. The battery 17 is the same battery as the battery 1.

The molar ratios r and the capacity retention rates of the batteries 11 to 46 were measured in the same manner as in Example 1. Tables 3 to 5 show the results.

TABLE 3

| | | | Amount of | Capacity |
|---|---|---|---|---|
| | | | BBTFES added | retention |
| | Positive electrode | Molar | (parts by | rate |
| | active material | ratio r | weight) | (%) |
| Battery 11 | Li_{0.97}Ni_{0.005}Co_{0.995}O₂ | 0.92 | 1 | 80.5 |
| Battery 12 | Li_{0.97}Ni_{0.05}Co_{0.95}O₂ | 0.92 | 1 | 80.7 |
| Battery 13 | Li_{0.97}Ni_{0.1}Co_{0.9}O₂ | 0.92 | 1 | 82.2 |
| Battery 14 | Li_{0.97}Ni_{0.3}Co_{0.7}O₂ | 0.91 | 1 | 83.0 |
| Battery 15 | Li_{0.97}Ni_{0.5}Co_{0.5}O₂ | 0.91 | 1 | 83.1 |
| Battery 16 | Li_{0.97}Ni_{0.7}Co_{0.3}O₂ | 0.90 | 1 | 85.4 |
| Battery 17 | Li_{0.97}Ni_{0.8}Co_{0.2}O₂ | 0.90 | 1 | 85.5 |
| Battery 18 | Li_{0.97}Ni_{0.9}Co_{0.1}O₂ | 0.90 | 1 | 85.7 |
| Battery 19 | Li_{0.97}Ni_{1.0}O₂ | 0.89 | 1 | 80.9 |

TABLE 4

| | | | Amount of | |
|---|---|---|---|---|
| | | | BBTFES | Capacity |
| | | | added | retention |
| | Positive electrode active | Molar | (parts by | rate |
| | material | ratio r | weight) | (%) |
| Battery 20 | Li_{0.97}Ni_{0.8}Co_{0.15}Al_{0.05}O₂ | 0.90 | 1 | 88.8 |
| Battery 21 | Li_{0.97}Ni_{0.8}Co_{0.15}Sr_{0.05}O₂ | 0.90 | 1 | 87.1 |
| Battery 22 | Li_{0.97}Ni_{0.8}Co_{0.15}Mg_{0.05}O₂ | 0.90 | 1 | 88.5 |
| Battery 23 | Li_{0.97}Ni_{0.8}Co_{0.15}Ti_{0.05}O₂ | 0.90 | 1 | 88.1 |
| Battery 24 | Li_{0.97}Ni_{0.8}Co_{0.15}Ca_{0.05}O₂ | 0.90 | 1 | 88.5 |
| Battery 25 | Li_{0.97}Ni_{0.8}Co_{0.15}Y_{0.05}O₂ | 0.90 | 1 | 84.8 |
| Battery 26 | Li_{0.97}Ni_{0.8}Co_{0.15}Zr_{0.05}O₂ | 0.90 | 1 | 85.4 |
| Battery 27 | Li_{0.97}Ni_{0.8}Co_{0.15}Ta_{0.05}O₂ | 0.90 | 1 | 85.3 |
| Battery 28 | Li_{0.97}Ni_{0.8}Co_{0.15}Zn_{0.05}O₂ | 0.90 | 1 | 84.8 |
| Battery 29 | Li_{0.97}Ni_{0.8}Co_{0.15}B_{0.05}O₂ | 0.90 | 1 | 84.9 |
| Battery 30 | Li_{0.97}Ni_{0.8}Co_{0.15}Cr_{0.05}O₂ | 0.90 | 1 | 84.9 |
| Battery 31 | Li_{0.97}Ni_{0.8}Co_{0.15}Si_{0.05}O₂ | 0.90 | 1 | 85.1 |
| Battery 32 | Li_{0.97}Ni_{0.8}Co_{0.15}Ga_{0.05}O₂ | 0.90 | 1 | 85.0 |
| Battery 33 | Li_{0.97}Ni_{0.8}Co_{0.15}Sn_{0.05}O₂ | 0.90 | 1 | 85.5 |
| Battery 34 | Li_{0.97}Ni_{0.8}Co_{0.15}P_{0.05}O₂ | 0.90 | 1 | 85.6 |
| Battery 35 | Li_{0.97}Ni_{0.8}Co_{0.15}V_{0.05}O₂ | 0.90 | 1 | 85.1 |
| Battery 36 | Li_{0.97}Ni_{0.8}Co_{0.15}Sb_{0.05}O₂ | 0.90 | 1 | 85.0 |
| Battery 37 | Li_{0.97}Ni_{0.8}Co_{0.15}Nb_{0.05}O₂ | 0.90 | 1 | 85.8 |
| Battery 38 | Li_{0.97}Ni_{0.8}Co_{0.15}Mo_{0.05}O₂ | 0.90 | 1 | 84.3 |
| Battery 39 | Li_{0.97}Ni_{0.8}Co_{0.15}W_{0.05}O₂ | 0.90 | 1 | 84.6 |
| Battery 40 | Li_{0.97}Ni_{0.8}Co_{0.15}Fe_{0.05}O₂ | 0.90 | 1 | 84.9 |
| Battery 41 | Li_{0.97}Ni_{0.5}Mn_{0.5}O₂ | 0.91 | 1 | 83.6 |
| Battery 42 | Li_{0.97}Ni_{0.5}Mn_{0.4}Co_{0.1}O₂ | 0.91 | 1 | 84.4 |
| Battery 43 | Li_{0.97}Ni_{0.33}Mn_{0.33}Co_{0.33}O₂ | 0.91 | 1 | 83.9 |

TABLE 5

| | | | Amount of | |
|---|---|---|---|---|
| | | | BBTFES | Capacity |
| | | | added | retention |
| | Positive electrode active | Molar | (parts by | rate |
| | material | ratio r | weight) | (%) |
| Battery | Li_{0.97}Ni_{0.8}Co_{0.15}Al_{0.05}O₂ | 0.91 | 1 | 85.8 |
| 44 | (80 wt %) + | | | |
| | Li_{0.97}Ni_{0.33}Mn_{0.33}Co_{0.33}O₂ | | | |
| | (20 wt %) | | | |
| Battery | Li_{0.97}Ni_{0.8}Co_{0.15}Al_{0.05}O₂ | 0.91 | 1 | 84.7 |
| 45 | (80 wt %) + | | | |
| | LiCoO₂ (20 wt %) | | | |
| Battery | Li_{0.97}Ni_{0.33}Mn_{0.33}Co_{0.33}O₂ | 0.91 | 1 | 82.0 |
| 46 | (30 wt %) + | | | |
| | LiCoO₂ (70 wt %) | | | |

The results shown in Tables 3 to 5 indicate that the combined use of a positive electrode active material that, after a discharge, is represented by the general formula LiₐNiₓM_{1-x-y}L_{y}O₂ (where M is at least one of Co and Mn, L is at least one selected from the group consisting of Al, Sr, Mg, Ti, Ca, Y, Zr, Ta, Zn, B, Cr, Si, Ga, Sn, P, V, Sb, Nb, Mo, W, and Fe, 0.85≦a≦0.92, 0.1≦x≦1, and 0≦y≦0.1) and a non-aqueous electrolyte containing BBTFES can provide batteries having excellent high-temperature cycle characteristics.

The results shown in Table 3 demonstrate that the Ni content in the positive electrode active material is preferably 0.1≦x≦0.9, more preferably 0.3≦x≦0.9, and particularly preferably 0.7≦x≦0.9.

The results shown in Table 4 reveal that the batteries 20 to 24, in which the element L includes at least one selected from the group consisting of Al, Sr, Mg, Ti, and Ca, have particularly good high-temperature cycle characteristics.

The results shown in Table 5 indicate that even the combined use of two or more kinds of composite oxides represented by the above-mentioned general formula can provide batteries having excellent high-temperature cycle characteristics.

### Example 4

Batteries 47 to 55 were produced in the same manner as in Example 1, except that the compounds shown in Table 6 were used as the fluorine-containing sulfonate compound added to the non-aqueous electrolyte.

The molar ratios r and the capacity retention rates of the batteries 47 to 55 were measured in the same manner as in Example 1. Table 6 shows the results. Table 6 also shows the result of the battery 1.

TABLE 6

| | | | Capacity |
|---|---|---|---|
| | Kind of fluorine-containing | | retention |
| | sulfonate compound | Molar | rate |
| | (Amount added: 1% by weight) | ratio r | (%) |
| Battery 1 | BBTFES | 0.90 | 85.5 |
| Battery | butyl 2,2,2-trifluoroethanesulfonate | 0.90 | 80.5 |
| 47 | | | |
| Battery | 1,4-butanediolbis(2,2,3,3,3- | 0.90 | 84.0 |
| 48 | pentafluoropropanesulfonate) | | |
| Battery | 1,4-butanediolbis(2,2,3,3,4,4,4- | 0.90 | 83.8 |
| 49 | heptafluorobutanesulfonate) | | |
| Battery | 1,4-butanediolbis(3,3,3- | 0.90 | 84.3 |
| 50 | trifluoropropanesulfonate) | | |
| Battery | 1,4-butanediolbis(4,4,4- | 0.90 | 83.7 |
| 51 | trifluorobutanesulfonate) | | |
| Battery | 1,4-butanediolbis(3,3,4,4,4- | 0.90 | 83.1 |
| 52 | pentafluorobutanesulfonate) | | |
| Battery | 1,2,3-propanetriol tris(2,2,2- | 0.90 | 81.4 |
| 53 | trifluoroethanesulfonate) | | |
| Battery | 1,2,3-propanetriol tris(2,2,3,3,3- | 0.90 | 81.2 |
| 54 | pentafluoropropanesulfonate) | | |
| Battery | 1,2,3,4-butanetetrol tetrakis (2,2,2- | 0.90 | 80.8 |
| 55 | trifluoroethanesulfonate) | | |

Table 6 indicates that even if the kind of the fluorine-containing sulfonate compound is changed, the combined use of the fluorine-containing sulfonate compound and the above-mentioned positive electrode active material can provide batteries having excellent high-temperature cycle characteristics. This is probably because the lithium compound on the positive electrode active material surface reacts with the fluorine-containing sulfonate compound, thereby forming a protective film on the positive electrode.

The batteries 1 and 48 to 52 including the fluorine-containing sulfonate compounds represented by the general formula (2) exhibited particularly good high-temperature cycle characteristics. The fluorine-containing sulfonate compounds as represented by the general formula (2) have, in their molecule, two units each containing a sulfonate group and an Rf group. It is thus believed that their reactivity with the lithium compound on the positive electrode is high and that excessive formation of the coating film is suppressed and a good coating film is formed.

The batteries 53 to 55, including the fluorine-containing sulfonate compounds whose molecule had three or more units each containing a sulfonate group and an Rf group, exhibited slight declines in capacity retention rate, compared with the batteries 1 and 48 to 52. This is probably because the reactivity with the lithium compound on the positive electrode is too high, so that the formation of the coating film becomes excessive, thereby slightly impeding the charge/discharge reactions.

Also, the battery 47, including the fluorine-containing sulfonate compound whose molecule had only one unit containing a sulfonate group and an Rf group, also exhibited a slight drop in capacity retention rate. The reactivity between the fluorine-containing sulfonate compound included in the battery 47 and the lithium compound on the positive electrode is low. It is thus believed that the formation of the coating film is insufficient so that side reaction between the non-aqueous electrolyte and the positive electrode active material cannot be sufficiently suppressed.

The results of Table 6 indicate that BBTFES is particularly excellent in cycle characteristics among the compounds represented by the general formula (2).

In BBTFES, one methylene group is sandwiched between the sulfonate group and the CF₃ group. In the case of elimination of the hydrogen atom of the methylene group and the fluorine atom of the CF₃ group, a carbon-carbon double bond is formed between the methylene group from which the hydrogen atom has been eliminated and the CF₂ group. Since π electrons are delocalized in the carbon-carbon double bond and the sulfonate group, the molecules from which the fluorine atom has been eliminated become significantly stable. It is thus believed that the reaction between the fluorine atom of the CF₃ group and the lithium compound on the positive electrode proceeds properly, so that a particularly good coating film is formed. Also, since the Rf group is the CF₃ group, the formation of the coating film does not become excessive and the charge/discharge reactions are not impeded. It is believed that this is also one of the reasons why the cycle characteristics are improved.

When the Rf group is a CF₃CF₂ group or the like, the fluorine atom is highly likely to be eliminated and the formation of the coating film becomes excessive. Hence, the charge/discharge reactions may be impeded.

### Example 5

Batteries 56 to 63 were produced in the same manner as in Example 1, except that the amount of BBTFES added per 100 parts by weight of the solvent mixture was varied as shown in Table 7.

The molar ratios r and the capacity retention rates of the batteries 56 to 63 were measured in the same manner as in Example 1. Table 7 shows the results.

TABLE 7

| | | | Amount of | |
|---|---|---|---|---|
| | | | BBTFES | Capacity |
| | Positive | | added | retention |
| | electrode active | Molar | (parts by | rate |
| | material | ratio r | weight) | (%) |
| Battery 56 | Li_{0.97}Ni_{0.8}Co_{0.2}O₂ | 0.90 | 0.05 | 51.0 |
| Battery 57 | Li_{0.97}Ni_{0.8}Co_{0.2}O₂ | 0.90 | 0.1 | 81.1 |
| Battery 58 | Li_{0.97}Ni_{0.8}Co_{0.2}O₂ | 0.90 | 0.5 | 83.4 |
| Battery 59 | Li_{0.97}Ni_{0.8}Co_{0.2}O₂ | 0.90 | 1 | 85.5 |
| Battery 60 | Li_{0.97}Ni_{0.8}Co_{0.2}O₂ | 0.90 | 2 | 85.2 |
| Battery 61 | Li_{0.97}Ni_{0.8}Co_{0.2}O₂ | 0.90 | 5 | 83.0 |
| Battery 62 | Li_{0.97}Ni_{0.8}Co_{0.2}O₂ | 0.90 | 10 | 80.7 |
| Battery 63 | Li_{0.97}Ni_{0.8}Co_{0.2}O₂ | 0.90 | 15 | 65.3 |

Table 7 shows that when the amount of BBTFES added is less than 0.1 part by weight per 100 parts by weight of the solvent mixture of the non-aqueous electrolyte, the cycle characteristics were low. This is probably because the added amount was small and the formation of the coating film on the positive electrode was thus insufficient. Also, when the amount of BBTFES added exceeded 10 parts by weight, the cycle characteristics were also low. This is probably because the coating film was too thick and the charge/discharge reactions were thus impeded. This indicates that the amount of the fluorine-containing sulfonate compound added is preferably 0.1 to 10 parts by weight, more preferably 0.5 to 5 parts by weight, and particularly preferably 0.5 to 2 parts by weight, per 100 parts by weight of the non-aqueous solvent.

### INDUSTRIAL APPLICABILITY

The non-aqueous electrolyte secondary battery of the present invention has high capacity and long life. Therefore, the non-aqueous electrolyte secondary battery of the present invention is useful, for example, as the power source for small-sized, portable appliances, etc.

1. A non-aqueous electrolyte secondary battery comprising: a positive electrode including a nickel-containing lithium composite oxide as a positive electrode active material; a negative electrode capable of absorbing and desorbing lithium; a separator interposed between said positive electrode and said negative electrode; and a non-aqueous electrolyte comprising a non-aqueous solvent and a solute dissolved in said non-aqueous solvent,
wherein said non-aqueous electrolyte includes a fluorine-containing sulfonate compound, and
in said nickel-containing lithium composite oxide after a discharge to a predetermined cut-off voltage of discharge, the molar ratio r of lithium to the other metal elements than lithium is 0.85 or more and 0.92 or less.

2. The non-aqueous electrolyte secondary battery in accordance with claim 1, wherein after said discharge to the predetermined cut-off voltage of discharge, said nickel-containing lithium composite oxide comprises at least one represented by the following general formula (1):
LiₐNiₓM_{1-x-y}L_{y}O₂
where M is at least one of Co and Mn, L is at least one selected from the group consisting of Al, Sr, Mg, Ti, Ca, Y, Zr, Ta, Zn, B, Cr, Si, Ga, Sn, P, V, Sb, Nb, Mo, W, and Fe, 0.85≦a≦0.92, 0.1≦x≦1, and 0≦y≦0.1.

3. The non-aqueous electrolyte secondary battery in accordance with claim 2, wherein said element L is at least one selected from the group consisting of Al, Sr, Mg, Ti, and Ca.

4. The non-aqueous electrolyte secondary battery in accordance with claim 1, wherein said fluorine-containing sulfonate compound comprises at least one represented by the following general formula (2): 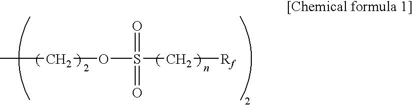
where n is an integer of 1 or higher, and Rf is an aliphatic saturated hydrocarbon group all the hydrogen atoms of which are replaced with fluorine atoms.

5. The non-aqueous electrolyte secondary battery in accordance with claim 1, wherein said non-aqueous electrolyte includes 0.1 to 10 parts by weight of said fluorine-containing sulfonate compound per 100 parts by weight of said non-aqueous solvent.

6. The non-aqueous electrolyte secondary battery in accordance with claim 1, wherein said nickel-containing lithium composite oxide included in said electrode immediately after production thereof is represented by the following general formula (3):
Li_{b}NiₓM_{1-x-y}L_{y}O₂
where M is at least one of Co and Mn, L is at least one selected from the group consisting of Al, Sr, Mg, Ti, Ca, Y, Zr, Ta, Zn, B, Cr, Si, Ga, Sn, P, V, Sb, Nb, Mo, W, and Fe, 0.955≦b≦0.995, 0.1≦x≦1, and 0≦y≦0.1.

7. The non-aqueous electrolyte secondary battery in accordance with claim 1, wherein said predetermined cut-off voltage of discharge is 2.0 V.

8. The non-aqueous electrolyte secondary battery in accordance with claim 1, wherein said fluorine-containing sulfonate compound comprises at least one selected from the group consisting of 1,4-buanediolbis (2,2,2-trifluoroethanesulfonate), butyl 2,2,2-trifluoroethanesulfonate, 1,4-buanediolbis (2,2,3,3,4,4,4-heptafluorobutanesulfonate), 1,4-butanediolbis (3,3,3-trifluoropropanesulfonate), 1,4-butanediolbis (4,4,4-trifluorobutanesulfonate), 1,4-butanediolbis (3,3,4,4,4-pentafluorobutanesulfonate), 1,2,3-propanetriol tris (2,2,2-trifluoroethanesulfonate), 1,2,3-propanetriol tris (2,2,3,3,3-pentafluoropropanesulfonate), and 1,2,3,4-butanetetrol tetrakis (2,2,2-trifluoroethanesulfonate).
